(19) United States
(12) Patent Application Publication
(10) Pub. No.: US 2026/0201737 A1
(43) Pub. Date: Jul. 16, 2026

(54) External Handle for a Leaf Element for a Vehicle, Arrangement of an External Handle on a Leaf Element for a Vehicle, and Vehicle

(71) Applicant: BAYERISCHE MOTOREN WERKE AKTIENGESELLSCHAFT, München (DE)

(72) Inventor: Erik BRADEN, Muenchen (DE)

(21) Appl. No.: 19/136,956

(22) PCT Filed: Feb. 5, 2024
(86) PCT No.: PCT/DE2024/100095

§ 371 Date: Jun. 9, 2025

(30) Foreign Application Priority Data
Mar. 2, 2023 (DE) 10 2023 105 204.7

(51) Int. Cl. E05B 81/76; E05B 81/20; E05B 85/10

(52) U.S. Cl. CPC E05B 81/77; E05B 81/20; E05B 85/10

(57) ABSTRACT

An external handle for a leaf element of a vehicle, having at least two surface regions which face away from one another, wherein the external handle has at least one sensor by way of which it is possible to detect both actuation of a first of the surface regions that is effected by a person and is intended to effect a first function and actuation of the second surface region, which faces away from the first surface region, that is effected by the person and is intended to effect the first function or a second function.

### BACKGROUND AND SUMMARY

This disclosure relates to an external handle for a leaf element of a vehicle. In addition, the disclosure relates to an arrangement of such an external handle on a leaf element for a vehicle. The disclosure also relates to a vehicle with at least one such arrangement.

A door handle unit for actuating a lock of a door or a flap is shown as known from DE 10 2015 101 164 A1, with a door handle and a carrier element, wherein the door handle can be attached to the door by the carrier element. A sensor element is intended that measures the approach of an object to the door handle. A display element is also provided, which provides at least one optical hint, the sensor element and the display element being arranged in the door handle unit, in particular the door handle. In addition, WO 2019/219508 A1 discloses a vehicle with a vehicle door adjustably arranged on a vehicle body and a device for manual and/or electromotive adjustment of the vehicle door relative to the vehicle body.

A door handle arrangement is also known from DE 20 2019 102 809U1 . In addition, EP 3 194 696 B1 discloses a handle device for a locking device for a movable part such as a door, flap or suchlike of a vehicle. Furthermore, EP 1 402 138 B1 discloses an external handle system for opening a vehicle, wherein a side door, a tailgate or a trunk is equipped with an access flap. EP 3 025 001 B1 also discloses a door handle system for a vehicle door.

An object of the present disclosure is to provide an external handle for a leaf element of a vehicle, an arrangement of such an external handle on a leaf element for a vehicle, and a vehicle with at least one such arrangement, so that a particularly advantageous actuation of the leaf element can be achieved in a particularly advantageous manner.

A first aspect of the disclosure relates to an external handle for a leaf element of a vehicle, in particular for a motor vehicle. The external handle can be or is arranged on the leaf element. This means that the vehicle, which is preferably designed as a motor vehicle, in particular as a motor vehicle and in particular as a passenger car, has the leaf element and the external handle arranged on the leaf element in its complete manufactured state. Thus, when the external handle is arranged on the vehicle door, the external handle is held and thus arranged on the leaf element. The external handle has at least two surface regions facing away from each other, namely a first surface region and a second surface region. The first surface region faces away from the second surface region, and the second surface region faces away from the first surface region. In particular, for example, the surface regions can be components of a surface of the external handle, also called the total surface. Preferably, the total surface is or forms a shell plating of the external handle, so that the surface regions are also parts of the shell plating referred to as shell plating parts. The shell plating of the external handle is also referred to as the handle shell plating or first shell plating. When the shell plating is referred to above and hereinafter, it is understood to mean the first shell plating of the external handle, unless otherwise specified. The first shell plating is a shell plating that can be perceived visually and haptically by a person present in the proximity of the external handle and the leaf element. This means that the person present in the proximity can see the first shell plating with their eyes and thus perceive it visually, and the person present in the proximity can touch the first shell plating and thus perceive it haptically, in particular in the complete manufactured state of the vehicle. The shell plating is therefore the aforementioned surface that can be perceived visually and haptically by the person present in the surrounding area, so that, for example, the surface or the first shell plating is the outermost surface of the external handle.

The leaf element is to be understood as a component which is formed on a body of the vehicle, for example is arranged as a self-supporting body, its interior, also referred to as the passenger cabin or passenger compartment through the body, movable, in particular pivotable, to hold or held, i.e. can be arranged or is arranged. When the vehicle is complete manufactured, the leaf element is thus formed in a complete manufactured state separately from the body and is held on the body so that it can be moved, in particular pivoted. In particular, a body opening of the body is assigned to the leaf element. The leaf element can be moved, in particular pivoted, relative to the body, between a closed position and at least one open position. In the closed position, at least one subregion of the body opening is locked by the leaf element. In the open position, the leaf element releases the subregion of the body opening. In particular, the external handle is arranged at or on an exterior of the leaf element, which, at least in the closed position of the leaf element, faces away from the interior of the vehicle and towards the surroundings of the vehicle and thus towards the leaf element. While the vehicle is in motion, people such as the driver of the vehicle may be in the interior of the vehicle. In particular, the leaf element can be a door, for example, in particular a side door, so that the body opening is a door opening, for example. Thus, for example, in the open position of the leaf element, the aforementioned person can enter the interior or exit the interior via the released subregion of the body opening. In particular, it is conceivable that the door opening is a side door opening and is thus arranged, for example, on a left or right side of the body and thus of the vehicle in the traverse direction of the vehicle. Furthermore, it is conceivable that the leaf element is a flap such as a tailgate or a front flap. For example, the leaf element can be a trunk lid or a trunk deck or a hood. Thus, for example, the body opening can be a door opening, in particular at the side or rear, or a front or rear storage space opening, so that, for example, a storage space, for example at the front or rear, in particular the trunk, of the vehicle can be accessible via the subregion of the body opening released in the open position of the leaf element. The leaf element is therefore an attachment part that is designed separately from the body and can be arranged or is arranged on the body in a movable, in particular, pivotable, manner, and can therefore be held or is held.

For example, the person present in the proximity can catch hold of the external handle with their hand and, for example, at least partially change their grip on it. Subsequently, the person can, for example, handle the leaf element via the external handle and thereby move, relative to the body, from the closed position into the open position, in particular by muscle power. In particular, if the leaf element is designed as a door, in particular as side door, the external handle is also referred to as a door handle or external door handle.

Furthermore, it is conceivable that, in particular in the complete manufactured state of the vehicle, a lock is assigned to the leaf element, which, in particular if the leaf element is designed as a door, in particular as a side door, is also referred to as a door lock or is designed as a door lock. By way of the lock, the leaf element, which can be moved, in particular pivoted, between the closed position and the at least one open position, in particular relative to the body and/or in a positive fit, must be secured or is secured so that undesired movement is not made, and therefore is prevented. For example, the lock can be unlocked, i.e., transferred from a locked state to an unlocked state, wherein the lock releases the leaf element, which is initially in the closed position, for movement from the closed position to the open position relative to the body.

In particular, the lock can be a component of the leaf element or can be held on the leaf element so that, for example, the lock with the leaf element can be moved, in particular, pivoted, relative to the body, between the closed position and at least one open position.

For example, the lock can be moved between the locked state and the unlocked state. By unlocking the lock, the lock is moved i.e., transferred from the locked state to the unlocked state. If, for example, the leaf element is initially in the closed position and the lock is in the locked state, the leaf element is secured in the closed position by way of the lock and thus against undesired movement into the open position relative to the body. To open the leaf element, i.e. to move it from the closed position to the open position, the lock is unlocked, i.e., transferred from the locked state to the unlocked state. As result, the lock releases the leaf element for a movement from the closed position to the open position relative to the body.

For example, a locking element such as a locking bolt, also known as a lock bolt, is attached to the body, in particular to a vehicle body, which is designed for example as a door pillar and is also known as a body pillar. In the closed position of the leaf element and in the locked state of the lock, for example, the lock, in particular a fork latch of the lock, interacts, in particular positively, with the locking element, as a result of which the leaf element can be secured or is secured positively in the closed position. For example, the lock has a lock element, which can be the aforementioned lock latch, for example. In the closed position of the leaf element and in the locked state of the lock, for example, the lock element interacts with the locking element, in particular in a positive fit, wherein the leaf element can be secured or locked in the closed position, in particular in a positive fit. For example, the lock element can be moved relative to a base element of the lock and, in particular relative to the locking element, between a locked position and an unlocked position, in particular translationally and/or rotationally.

In particular, for example, the lock element can be moved from the locked position to the unlocked position by unlocking the lock. In the closed position of the leaf element and in the locked position of the lock element, the lock element interacts, in particular in a positive fit with the locking element, thereby securing or locking the leaf element in the closed position. By or when unlocking the lock, for example, the lock element is moved from the locked position into the unlocked position, in which the lock element does not interact with the locking element. This releases the leaf element for a movement relative to the body from the locked position to the open position.

In order to be able to achieve a particularly advantageous actuation of the leaf element in a particularly advantageous manner, it is provided according to the disclosure that the external handle has at least one sensor, also referred to as the first sensor, by way of which both an actuation effected by the person present in the surrounding area and intended to effect a first function, i.e., actuation of the first surface region, and an actuation effected by the person and intended to effect the first function or a second function, i.e., actuation of the second surface region facing away from the first surface region, can be detected. In other words, by operating, i.e. actuating the first surface region, the first function can be effected, i.e. triggered, wherein the first function can be a function of the vehicle, in particular of the leaf element. By operating, i.e. actuating the second surface region, the first function can be effected, i.e. triggered, or by operating, i.e. actuating the second surface region, the second function, which differs from the first function, can be effected, i.e. triggered.

For example, the second function is a function of the vehicle, in particular of the leaf element. It is provided that the same sensor can be used to detect both the actuation of the first surface region and the actuation of the second surface region. The actuation or operation of the first surface region is often referred to as the first actuation or the first operation, and the actuation or operation of the second surface region is also referred to as the second actuation or second operation. Since both the first actuation and the second actuation can be detected by the same sensor, such an arrangement can be avoided in which a first sensor, which in relation to the first actuation and the second actuation is designed only for detecting the first actuation, and an additional, second sensor are provided, which in relation to the first actuation and the second actuation is designed only for detecting the second actuation, so that the number of parts and thus the costs and the weight of the external handle can be kept particularly low. The disclosure thus makes it possible to create an operating point outside the leaf element, i.e. on the exterior of the leaf element, which can be designed in a particularly space-saving manner because both the first actuation and the second actuation can be detected by way of the same sensor. This can save installation space, for example, which can be used for other components, such as electronic elements and/or sensors.

Preferably, the operator console comprises the said at least one sensor.

Preferably, the external handle has at least one second sensor or several second sensors, wherein the previous and following explanations regarding the at least one sensor, by way of which both the first actuation and the second actuation can be detected, can also be readily transferred to the respective second sensor and vice versa. In this way, a respective and particularly large detection region can be detected for the respective actuation or operation, in which the respective actuation of the respective surface region can be reliably and precisely detected.

Since both the first actuation of the first surface region and the second actuation of the second surface region can be detected by way of the same sensors, an actuation of the external handle can be achieved on both sides in a particularly cost-, construction space- and weight-saving manner, wherein the actuation on both sides is also referred to as bidirectional actuation. Since the external handle and thus the surface regions as well as, in particular, the operator console, are arranged on the exterior of the leaf element and thus in the indicated surrounding area, the operator console is an open operator console or an operator console that is easily and conveniently accessible from the outside, by way of which the respective function can easily and conveniently be effected i.e. triggered. Since the operator console can be designed particularly small, thus in a particularly space-saving manner; moreover, a particularly good optic impression overall can be ensured.

In principle, it is conceivable that the first surface region and/or the second surface region could be curved and, for example, concave or convex. It is also conceivable that the respective surface region extends in a respective plane so that, for example, the first surface region extends in a first plane and the second surface region extends in a second plane. It is conceivable that the planes are spaced apart and run parallel to each other, or that the planes run at an angle or perpendicular to each other.

The respective actuation of the respective surface element is understood to mean, for example, that at least one touch of the respective surface region is made by the person. Furthermore, the respective actuation of the respective surface region means, for example, that a respective movement of the respective surface region takes place, in particular relative to the respective other surface region. In particular, the movement is a so-called micro-movement, which only takes place over a very short distance or a very short path.

In order to be able to detect both the first actuation of the first surface region and the second actuation of the second surface region advantageously, in particular precisely, by way of the same sensor and thus ensure particularly advantageous, in particular convenient and precise, actuation of the leaf element, it is provided in one embodiment of the disclosure that the sensor, in particular precisely, provides an electric and/or magnetic field and is designed to detect both a first change in the field resulting from the first actuation of the first surface region and also a second change in the field resulting from the second actuation of the second surface region and thus the second actuation of the second surface region.

In order to be able to precisely detect both the first actuation and the second actuation and thus ensure a particularly advantageous actuation of the leaf element, it is provided in a further embodiment of the disclosure that the first surface region is assigned a first detection element provided in addition to the sensor, which can be moved in a first direction relative to the sensor and relative to the field by the first actuation of the first surface region and thereby causes the first change. The second surface region is assigned a second detection element provided in addition to the sensor and in addition to the first detection element, which can be moved by the second actuation of the second surface region in a second direction opposite to the first direction relative to the sensor and relative to the field, thereby effecting the second change. Preferably, the first detection element is arranged outside the second detection element. For example, the surface regions are formed by a housing of the external handle, wherein a receiving space of the external handle, also referred to as interior, is formed by the housing, in particular by a surface of the housing on the inner circumference side. The surface regions face away from the receiving space, with the surface on the inner circumferential side facing away from the surface regions and towards the interior. In particular, it is provided that the detection elements are arranged in the receiving space. For example, the respective detection element is formed from a magnetic, in particular ferromagnetic, and/or in particular from an electrically conductive material, so that the respective movement of the respective detection element relative to the fields leads to the respective change in the field. As a result, the respective actuation can be detected precisely.

In order to be able to reliably detect the respective actuation or operation of the respective surface region and subsequently ensure a particularly advantageous, in particular convenient, actuation of the leaf element, it is provided in a further embodiment of the disclosure, that the first surface region can be moved in the first direction relative to the sensor and relative to the field by the first actuation of the first surface region, wherein the first detection element is coupled to the first surface region and can thereby be moved with the first surface region in the first direction relative to the sensor and relative to the field. It is preferably provided that the second surface region is moveable by the second actuation of the second surface region in the second direction relative to the sensor and relative to the field, the second detection element being coupled to the second surface region and thereby being movable as well alongside the second surface region in the second direction relative to the sensor and relative to the field. In particular, the first surface region and with it the first detection element are preferably movable in the first direction relative to the sensor, relative to the field and relative to the second surface region and relative to the second detection element, and preferably the second surface region and the second detection element are movable in the second direction relative to the sensor, relative to the field, relative to the first detection element and relative to the first surface region. This ensures reliable and precise detection of the respective actuation.

So that the person present in the surrounding area can particularly conveniently actuate the respective surface region and thus the leaf element, it is provided in a further embodiment of the disclosure that one of the directions faces away from the respective surface region of the leaf element, wherein the other direction points out from the respective surface region to the leaf element.

A further embodiment is characterized in that the sensor is designed as an inductive sensor. This makes the sensor particularly rugged against external influences or surrounding area influences such as water and thus rain. This prevents the inadvertent actuation of the respective surface region, for example.

It has proven particularly advantageous for the sensor to have at least one strain gauge. The strain gauge can particularly advantageously detect both a deformation, for example of a substrate on which the strain gauge is provided, that occurs in a first direction or in the first direction and that results, in particular, from the first actuation, and a deformation, in particular of the substrate, that occurs in a second direction or opposite the first direction and that results, for example, from the second actuation, so that the operations can be detected particularly well and precisely. In particular, the substrate is a component of the external handle.

A second aspect of the disclosure relates to an arrangement of an external handle, in particular according to the first aspect of the disclosure, on a leaf element for a vehicle, in particular for a motor vehicle. In the arrangement, the external handle is held and thus arranged on the leaf element. In addition, in the arrangement, the external handle has at least two surface regions facing away from one another, specifically a first surface region and a second surface region. The first surface region faces away from the second surface region, and the second surface region faces away from the first surface region.

To enable a particularly advantageous actuation of the leaf element to be achieved in a particularly advantageous manner, it is provided according to the disclosure that the external handle has at least one sensor, also referred to as the first sensor, by way of which both an actuation effected by the person present in the surrounding area and intended to effect a first function, i.e., actuation of the first surface region, and an actuation effected by the person and intended to effect the first function or a second function, that is to say, actuation of the second surface region that points away from the first surface region can be detected. Advantages and advantageous embodiments of the first aspect of the disclosure are to be regarded as advantages and advantageous embodiments of the second aspect of the disclosure, and vice versa.

In a particularly advantageous embodiment of the disclosure, it is provided that one of the surface regions faces the leaf element and the other surface region, wherein the other surface region is turned away from the leaf element and from one surface region. This enables a particularly advantageous arrangement of the surface regions relative to each other to be achieved, so that the person present in the area can operate the respective surface region and thus the leaf element particularly conveniently.

To achieve a particularly convenient actuation of the leaf element, and thus of the vehicle, it is provided in a further embodiment of the disclosure that the first function comprises an electrical unlocking of the lock. Electrical unlocking of the lock is understood to mean that an electrical unlocking of the lock is or can be effected by the first actuation of the first surface region. In other words, the first actuation of the first surface region allows the lock to be electrically unlocked, i.e. to be transferred electrically from the locked state to the unlocked state. In particular, the electrical unlocking of the lock is understood to mean that, for example as a result of the first actuation of the first surface region, an electrically operable actuator, also referred to as the first actuator, which is embodied, for example, as an electric motor, is actuated, in particular electrically actuated. This actuation of the first actuator causes the first actuator to be electrically operated, so that the lock element, for example, is moved by way of the first actuator, in particular using electric power with which the first actuator is supplied, and thus electrically, from the locked position to the unlocked position. This means that the lock element is moved electrically from the locking position into the unlocking position, through which the lock is unlocked electrically, i.e. using the aforementioned electrical energy. A movement of the leaf element from the closed position to the open position following the electrical unlocking of the lock can then be carried out manually by the aforementioned person, for example, and thus in particular by muscle power, in particular by the person manually exerting a force, in particular a tension force or compressive force, onto the external handle, in particular onto the first surface region and thus via the first surface region on the external handle and thus exerting the force over the external handle onto the leaf element and through this moves the leaf element relative to the body from the closed position into the open position, in particular while the person exerts the force onto the external handle, in particular the first surface region.

To be able to achieve a particularly convenient actuation, it is provided in a further embodiment of the disclosure that the second function comprises the electric unlocking of the lock as well as additionally an automatic moving of the leaf element from the closed position into the open position effected by way of a second actuator, wherein, in the first function, the automatic moving of the leaf element from the closed position into the open position effected by way of the second actuator does not take place. In particular, the second actuator is an electrically operatable actuator, in particular an electric motor. It is thus preferably provided in the second function that the leaf element is moved, in particular electrically, i.e. preferably using electrical energy, with which, for example, the second actuator is supplied, through the second actuation of the second surface region, by way of the second actuator and thus is automatically moved from the closed position into the open position relative to the body, in particular after the lock was electrically unlocked, in particular by way of the first actuator. For example, the second actuator is a component of an electrically operatable motion apparatus, which for example comprises the second actuator and possibly also the first actuator. Through the second actuation of the second surface region for example the first actuator, in particular controlled electrically, through which the lock is electrically unlocked by way of the first actuator. Moreover, the second actuator is controlled, in particular electrically, for example through the second actuation of the second surface region, whereby the second actuator is operated, in particular electrically through this control of the second actuator, in particular through the second actuator being supplied with electrical energy. Thus, the leaf element, for example moves, in particular pivots, in particular using electrical energy, with which the second actuator is supplied, by way of the second actuator and thus electrically, relative to the body, from the closed position into the open position. The lock can thus be unlocked particularly conveniently, and the leaf element can be opened particularly conveniently, therefore moved from the closed position into the open position.

A third aspect of the disclosure relates to a vehicle preferably designed as a motor vehicle, in particular as a motor vehicle, and in particular as a passenger car, which has at least one arrangement according to the first aspect of the disclosure.

Advantages and advantageous embodiments of the first and second aspect of the disclosure must be regarded as advantages and advantageous embodiments of the third aspect of the disclosure and vice versa.

Further details of the disclosure result from the following description of a preferred embodiment with the related drawing.

### BRIEF DESCRIPTION OF THE DRAWING

FIG. 1 shows a schematic section view of an arrangement of an external handle on a leaf element for a vehicle.

### DETAILED DESCRIPTION OF THE DRAWING

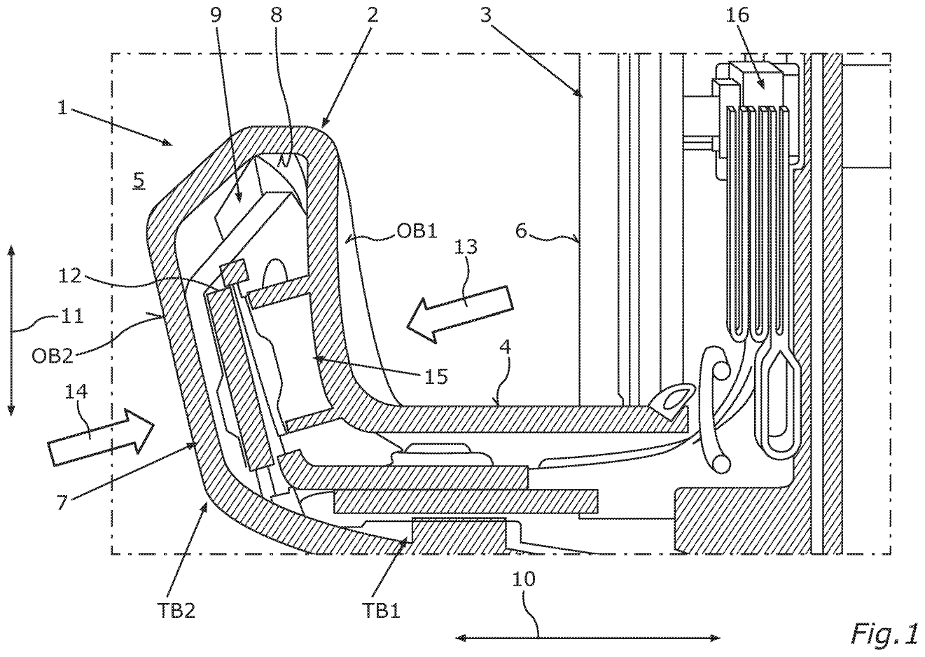

FIG. 1 shows in sections in a schematic section view an arrangement 1 of an external handle 2 on a leaf element 3 of a vehicle. This means that the vehicle, whose interior is also referred to as passenger cabin or passenger compartment, is formed by a body of the vehicle, in particular designed as a self-supporting automotive body, has the body, the leaf element 3 and the external handle 2 arranged, i.e. held on it. This means that in the arrangement 1 the external handle 2 is held on a leaf element 3. The external handle 2 has a surface 4 also referred to as total surface region, which is also referred to as first surface. The surface 4 is the most external surface of the external handle 2, so that the surface 4 is also referred to as first automotive body shell or exterior shell of the handle automotive body shell of the external handle 2. A person present in a surrounding area 5 of the external handle 2 and the leaf element 3 can perceive the first automotive body shell of the external handle 2, therefore the surface 4 visually and haptically. The leaf element 3 has an automotive body shell 6 also referred to as second automotive body shell or leaf element shell, which is visually and haptically perceivable by the person present in the surrounding area 5. For example, the first automotive body shell of the external handle 2 is formed by a housing 7 of the external handle 2. The housing 7, in particular a shell 8 on the internal circumference side of the housing 7 facing away from the surface 4, forms or limits, in particular directly, a receiving chamber 9, which is an interior of the external handle 2. The housing 7 can for example be formed in many parts and thereby for example have several separately designed and interconnected housing parts.

The body of the vehicle is preferably designed as a self-supporting automotive body. In the embodiment shown in FIG. 1 the leaf element 3 is designed as a door, in particular a side door. A body opening of the body is assigned to the leaf element 3, wherein in the embodiment shown in FIG. 1 the body opening is designed as a side door opening. The leaf element 3 is movable at the body between a closed position opening and at least one open position relative to the body is held, therefore arranged, movably, in particular pivotably. In the closed position of the leaf element 3 at least one subregion of the body opening is locked by the leaf element 3. In the open position, the leaf element 3 releases at least the subregion of the body opening, so that for example the person present in the surrounding area 5 can enter the interior via the released subregion of the body opening. Furthermore, for example, the person first present in the interior can exit the released subregion from the interior and thus reach at or in the surrounding area 5.

The leaf element 3 has for example a shell 16. Since in the embodiment shown in FIG. 1 the leaf element 3 is designed as a door, in particular a side door, the shell 16 is also referred to as door shell. The leaf element 3 thereby has a body paneling element also simply referred to as paneling element, which is not recognizable in FIG. 1 and for example is designed separately from the shell 16 and, in particular, is directly attached to the shell 16. The body paneling element is also referred to as door paneling or exterior door paneling. Since in the embodiment shown in FIG. 1 the leaf element 3 is designed as a door, in particular as a side door, the external handle 2 is also referred to as door handle or external handle of the door. The person present in the surrounding area 5 can, while they are present in the surrounding area 5, grip the external handle 2 with their hand and thereby change their grip around it, in particular at least partly and thereby for example exert a force, in particular tensile and/or compressive force, on the external handle 2 and via the external handle 2 onto the leaf element 3.

A lock not presented in FIG. 1, is provided, for example, which can be, for example, the leaf element 3 or a component of the leaf element held at the leaf element 3, so that the lock is co-movable, in particular co-pivotable with the leaf element 3 relative to the body of the vehicle between the open position and the closed position. Since the leaf element in the embodiment shown in FIG. 1 is designed as a door, in particular as a side door, the lock for example is designed as a door lock. By way of the lock, the leaf element 3 is held relative to the body in the closed position and thus secured in the closed position, so that the leaf element 3 can be secured by way of the lock against a movement occurring relative to the body from the closed position into the open position. For this purpose, the lock is or becomes locked in the closed position of the leaf element 3, i.e. the lock finds itself in a locked condition of the lock. The lock can be unlocked for example, that is to say brought i.e. led from the locked condition into an unlocked condition of the lock. Through bringing the lock from the locked condition into the unlocked condition of the lock the lock initially releases the leaf element 3 in the closed position for movement occurring relative to the body of the vehicle from the closed position into the open position.

It is recognizable from FIG. 1 that the external handle 2 has at least two surface regions OB1 und OB2 facing away from each other. The first surface region OB1 is a first part of the surface 4, and the second surface region OB2 is a second door of the surface 4.

To be able to achieve a haptically particularly advantageous and in particular ergonomic and convenient actuation, in particular operation, of the leaf element 3 designed here as a vehicle door, in the embodiment shown in FIG. 1 it is provided that the external handle 2, which is also referred to as handle element, forming a first subregion of the external shell of the first automotive body shell of the external handle 2, also referred to as body part, has a first subregion TB, which has a first extension direction and thus extends along the first extension direction. The first extension direction is illustrated by a double arrow 10. In the present disclosure, it is provided that the first subregion TB1 protrudes into or along the first extension direction from the leaf element 3, in particular from the automotive body shell 6. In the installation position of the leaf element 3 and in the closed position of the leaf element 3 for example the first extension direction runs in a vehicle transverse direction, in particular outwards and thus toward the surrounding area 5, so that it is preferably provided that in the installation position of the leaf element 3 and in the closed position of the leaf element 3 the first subregion TB1 protrudes toward the surrounding area 5 and thus away from the interior from the leaf element 3. The external handle 2 and the leaf element 3 thereby assume their respective installation position in a complete manufactured condition of the vehicle showing the leaf element 3 and the external handle 2, wherein the installation position is shown in FIG. 1.

In addition, the external handle 2 has a second subregion TB2 also referred to as second body part, which forms a second external shell part of the first automotive body shell of the external handle 2. The second subregion TB2 of the external handle 2 is closed at the first subregion TB1 of the external handle 2, in particular at the end of the first subregions TB1 of the external handle 2 facing away from the leaf element 3, wherein the second subregion TB2 of the external handle 2 protrudes in an extension direction running slanted or perpendicular to the first extension direction (double arrow 10), second extension direction from the first section TB1 of the external handle 2. The second

extension direction is illustrated by a double arrow 11. Through this, for example, the second section TB2 is separated from the leaf element 3 and arranged in at least partial overlapping with the leaf element 3. In particular, the second section TB2 is stretched along the second extension direction. In the installation position of the leaf element 3 and of the external handle 2 and related to the closed position of the leaf element 3, for example, the second extension direction runs in the vehicle horizontal direction upward or the second extension direction points upward in the vehicle vertical direction. For example, in the installation position of the leaf element 3 and the external handle 2 and related to the closed position of the leaf element 3 the second subregion TB2 of the external handle 2 runs inwards in the vehicle transverse direction and thus to the interior through the leaf element 3 and thus for example overlaps through a part of the automotive body shell 6. This enables the person present in the surrounding area 5, for example, to grip the external handle 2, in particular the second subregion TB2, particularly advantageously and ergonomically with their hand, in particular to reach behind it, particularly such that the person can move at least one of their fingers or a plurality of their fingers between the second subregion TB2 of the external handle 2 and the leaf element 3, for example. This enables the person to exert a force particularly advantageously on the base element, thereby making it particularly advantageous to handle the leaf element 3, i.e. in particular to move it, in particular to pivot it, relative to the superstructure.

In order to be able to achieve a haptically particularly advantageous and in particular ergonomic and convenient actuation, in particular operation, of the leaf element 3, it is provided in the embodiment shown in FIG. 1 that the external handle 2, in particular as a whole and thus viewed as a whole, is L-shaped or V-shaped and thus has an L-shape or V-shape due to the fact that the second subregion TB2 projects from the first subregion TB1 in the second direction of extension. The subregions TB1 and TB2 of the external handle 2 form the L-shape or the V-shape, wherein the subregions TB1 and TB2 of the external handle 2 are respective legs of the L-shape or the V-shape. In particular, it is provided that the external handle 2 is connected to the leaf element 3 via the first subregion TB1 of the external handle 2. Furthermore, it can be seen from FIG. 1 that the surface regions OB1 and OB2 are components of the second subregion TB2 or are formed by the second subregion TB2. In other words, for example, the surface regions OB1 and OB2 are areas or parts of the subregion TB2.

In order to be able to achieve a particularly advantageous actuation of the leaf element 3 in a particularly advantageous way, the external handle 2 has at least one sensor 12 arranged in particular in the receiving space 9, wherein both a first actuation of the first surface region OB1 caused by the person present in the surrounding area 5 and a second actuation of the second surface region OB2 caused by the person can be detected by way of the same sensor 12. The first actuation is illustrated in FIG. 1 by an arrow 13 and takes place, for example, in such a way that the person exerts a first force, in particular a first compressive force, on the first surface region OBI, in particular in a first direction illustrated by the arrow 13, and thus presses in the first direction on the surface region OB1, in particular with one of their fingers. The second actuation is illustrated in FIG. 1 by an arrow 14 and takes place, for example, in such a way that the person exerts a second force, in particular a second compressive force, on the surface region OB2, in particular in a second direction illustrated by the arrow 14, and thus presses in the second direction on the surface region OB2. It can be seen that the first direction is opposite to the second direction and vice versa. By way of the first actuation of the surface region OB1, also referred to as the first actuation, a first function, in particular of the vehicle and in particular of the leaf element 3, can be effected, and, for example, the first function or preferably a second function different from the first function, in particular of the vehicle and in particular of the leaf element 3, can be effected by the second actuation. In other words, for example, the first actuation triggers, i.e. starts, the first function, and the second actuation triggers, i.e. starts, either the first function or the second function.

It can be seen from FIG. 1 that the sensor 12 is arranged in the receiving space 9 and is held, for example, at least indirectly on the housing 7. For example, the sensor 12 is encapsulated with the housing 7, i.e. with at least one of the housing parts, in particular in such a way that, for example, the sensor 12 is at least partially encapsulated in the housing 7, in particular in at least one of the housing parts.

It can be seen from FIG. 1 that the sensor 12 is arranged in the receiving space 9 and is held, for example, at least indirectly on the housing 7. For example, the sensor 12 is encapsulated with the housing 7, i.e. with at least one of the housing parts, in particular in such a way that, for example, the sensor 12 is at least partially encapsulated in the housing 7, in particular in at least one of the housing parts. It can be seen from FIG. 1 that the sensor 12 is arranged in the receiving space 9 and is held, for example, at least indirectly on the housing 7. For example, the sensor 12 is encapsulated with the housing 7, i.e. with at least one of the housing parts, in particular in such a way that, for example, the sensor 12 is at least partially encapsulated in the housing 7, in particular in at least one of the housing parts. It can be seen from FIG. 1 that the sensor 12 is arranged in the receiving space 9 and is held, for example, at least indirectly on the housing 7. For example, the sensor 12 is encapsulated with the housing 7, i.e. with at least one of the housing parts, in particular in such a way that, for example, the sensor 12 is at least partially encapsulated in the housing 7, in particular in at least one of the housing parts. It can be seen from FIG. 1 that the sensor 12 is arranged in the receiving space 9 and is held, for example, at least indirectly on the housing 7. For example, the sensor 12 is encapsulated with the housing 7, i.e. with at least one of the housing parts, in particular in such a way that, for example, the sensor 12 is at least partially encapsulated in the housing 7, in particular in at least one of the housing parts.

To enable the actuation in each case to be detected precisely and reliably, sensor 12 is preferably designed as an inductive sensor.

For example, the first detection element is coupled, i.e. connected, at least indirectly, in particular directly, to the first surface region OB1, and can thereby be moved along with the surface region OB1. For example, the second detection element is at least indirectly, in particular directly, coupled to the second surface region OB2, i.e. connected to and thus capable of moving alongside the second surface region OB2.

It is particularly clear from FIG. 1 that the surface region OB2 leaf element 3, in particular the shell plating 6, and facing away from the surface region OB2, wherein the surface region OB2 is facing away from the surface region OB1 and is facing away from the leaf element 3. Thus, in the closed position of leaf element 3, surface region OB2 is facing away from the interior, and surface region OB1 is facing toward the interior in the closed position of the leaf element 3.

The respective detection element is at least partially embedded, for example, in the housing 7, in particular in a respective one of the housing parts of the housing 7, in particular such that the housing 7, for example, in particular the respective housing part, is cast, in particular injection molded, onto the respective detection element. This enables the respective detection element to be coupled to the respective surface region OB1, OB2.

### LIST OF REFERENCE SIGNS

1 Arrangement
2 External handle
3 Leaf element
4 Surface
5 Surrounding area
6 Automotive body shell
7 Housing
8 Shell on the inner circumference side
9 Receiving chamber
10 Double arrow
11 Double arrow
12 Sensor
13 Arrow
14 Arrow
15 Dashed line
16 Shell
OB1 First surface region
OB2 Second surface region
TB1 First subregion
TB2 Second subregion

1.-14. (canceled)

15. An external handle for a leaf element of a vehicle, with at least two surface regions pointing away from each other, the external handle comprising:
at least one sensor, by way of which both an operation of a first of the surface regions effected by a person and intended to effect a first function and an operation of the second surface region pointing away from the first surface region effected by the person and intended to effect the first function or a second function can be detected.

16. The external handle according to claim 15, wherein the sensor provides an electric and/or magnetic field and is designed to detect both a first change in the field resulting from the operation of the first surface region and thus the operation of the first surface region and a second change in the field resulting from the operation of the second surface region and thus the operation of the second surface region.

17. The external handle according to claim 16, wherein:
a first detection element provided in addition to the sensor is associated with the first surface region, which detection element can be moved in a first direction relative to the sensor and relative to the field by the operation of the first surface region in a first direction relative to the sensor and relative to the field, thereby effecting the first change; and
a second detection element provided in addition to the sensor and in addition to the first detection element is associated with the second surface region, which second detection element is movable relative to the sensor and relative to the field in a second direction opposite to the first direction by the operation of the second surface region, thereby effecting the second change.

18. The external handle according to claim 17, wherein:
the first surface region is moveable in the first direction by actuating the first surface region in the first direction relative to the sensor and relative to the field, wherein the first detection element is coupled to the first surface region and thereby movable with the first surface region in the first direction relative to the sensor and relative to the field; and
the second surface region is movable in the second direction relative to the sensor and relative to the field by actuation of the second surface region.

19. The external handle according to claim 15, wherein the sensor has at least one strain gauge.

20. The external handle according to claim 15, wherein the sensor is designed as an inductive sensor.

21. An arrangement of an external handle on a leaf element for a vehicle, in which the external handle is held on the leaf element and has at least two surface regions pointing away from one another, the external handle comprising:
at least one sensor, by way of which both an actuation of a first surface region caused by a person and intended to effect a first function and an actuation of the second surface region pointing away from the first surface region caused by the person and intended to effect the first function or a second function can be detected.

22. The arrangement according to claim 21, wherein one of the surface regions is facing the leaf element and facing away from the other surface region, wherein the other surface region is facing away from the leaf element and facing away from the one surface region.

23. The arrangement according to claim 21, wherein:
the first surface region is associated with a first detection element which is provided in addition to the sensor and which can be moved in a first direction relative to the sensor and relative to the field by the in a first direction relative to the sensor and relative to the field, thereby effecting the first change;
the second surface region is associated with a second detection element provided in addition to the sensor and in addition to the first detection element, which second detection element is movable relative to the sensor and relative to the field in a second direction opposite to the first direction by the operation of the second surface region, thereby effecting the second change.

24. The arrangement according to claim 23, wherein:
the first surface region is movable in the first direction relative to the sensor and relative to the field by the actuation of the first surface region, the first detection element being coupled to the first surface region and thereby co-movable with the first surface region in the first direction relative to the sensor and relative to the field; and
the second surface region is movable in the second direction relative to the sensor and relative to the field by the actuation of the second surface region, the second detection element being coupled to the second surface region and thereby co-movable with the second surface region in the second direction relative to the sensor and relative to the field, wherein the second detection element is coupled to the second surface region and thereby movable with the second surface region in the second direction relative to the sensor and relative to the field.

25. The arrangement according to claim 23, wherein one of the directions points away from the leaf element starting from the respective surface region and the other direction points towards the leaf element starting from the respective surface region.

26. The arrangement according to one of claim 21, wherein the first function comprises an electrical unlocking of a lock, by way of which the leaf element, which can be arranged movably on a body of the motor vehicle between a closed position and at least one open position, is to be secured in the closed position.

27. The arrangement according to claim 21, wherein the second function comprises the electrical unlocking of the lock and additionally an automatic movement of the leaf element from the closed position and the open position effected by way of an actuator, whereby in the first function the automatic movement of the leaf element from the closed position into the open position effected by way of the actuator is omitted.

28. A vehicle, with at least one arrangement according to claim 21.
